(19) United States
(12) Patent Application Publication
(10) Pub. No.: US 2011/0154199 A1
(43) Pub. Date: Jun. 23, 2011

(54) Method of Playing An Enriched Audio File

(75) Inventors: Brian Maffitt, Chestnut Ridge, NY (US); Wes Smith, Staten Island, NY (US)

(73) Assignee: Flying Car Ltd., Park Ridge, NJ (US)

(21) Appl. No.: 12/640,196

(22) Filed: Dec. 17, 2009

(51) Int. Cl. G06F 17/00; G06F 3/048

(52) U.S. Cl. 715/716; 700/94

(57) ABSTRACT

A computer implemented method to playback an enriched audio file that includes advancing a file that includes a timeline of events synchronized to an audio file. The timeline of events includes a first event scheduled to be performed before a second event. The audio file is played. An override mode is entered such that the performance of the timeline of events is not synchronized to the audio file. The second event is performed before the first event while the audio file is played and the override mode is exited such that the timeline of events is synchronized to the audio file.

### TECHNICAL FIELD

This disclosure relates to the playback of enriched audio files.

### BACKGROUND

A typical audio book is a spoken word reading of a book, such as a novel, a biography or a self help book. Audio books allow the user to enjoy a book without having to actually read the book. These audio books often do not incorporate other media forms, such as videos or illustrations.

In recent years, audio books have become a popular medium to distribute a variety of literature such as novels and self help books. One reason for the increased popularity of audio books is that audio books can be distributed in many different formats. For example, audio books are distributed in CD format and are widely available as downloadable digital formats, such as MP3 (.mp3) or Windows Media Audio (.wma). In addition, audio books have gained in popularity because of the widespread use of laptop computers, portable audio players (e.g., iPods) and smart phones (e.g., iPhones and Blackberry devices).

In addition to the popularity of audio books, other spoken word audio programs have also increased in popularity. For example, podcasts (i.e., Internet syndicated audio programs) and digitized versions of AM/FM radio programs such as “This American Life” are commonly distributed through the Internet and enjoyed by various users.

### SUMMARY

This specification describes technologies relating to playback of an enriched audio file.

In one aspect, playing an enriched audio file includes advancing a file, wherein the file includes a timeline of events synchronized with an audio file. The timeline of events include a first event scheduled to be performed before a second event. The audio file is played and an override mode is entered. In the override mode, the performance of the events is not synchronized to the audio file and the second event is performed before the first event while the audio file is played. The override mode is exited and the timeline of events is synchronized with the audio file.

In another aspect, enhancing an audio file includes marking an audio file with a first event marker at a specific time or time period in the audio file. The audio file is marked with a second event marker at a specific time or time period in the audio file. A first event that is associated with the first event marker is retrieved, and a second event that is associated with the second event marker is retrieved. The first event is displayed on a user interface during playback of the audio file wherein the first event is displayed at the specified time in the audio file designated by the first event marker. The second event is displayed on a user interface during playback of the audio file wherein the second event is displayed at the specified time in the audio file designated by the second audio event.

Other embodiments of this aspect include corresponding systems, apparatus, and computer programs, configured to perform the actions of the methods, encoded on computer storage devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for playing enriched audio files.

FIG. 2 is an illustration of an example audio file, an example core pilot file and co-pilot files.

FIG. 3 is an illustration of an example cargo file.

FIG. 4 is a flowchart illustrating an example method of playing enriched audio files.

FIG. 5 is a flowchart illustrating an example method of playing enriched audio files in override mode.

FIG. 6 is an illustration of a normal playback mode.

FIG. 7 is an illustration of an override mode.

FIG. 8 is a block diagram of an example system to implementing a system for playing enriched audio files.

FIG. 9 is a flowchart illustrating a second example method of playing enriched audio files in override mode.

FIG. 10 is an illustration of a second example override mode.

Like reference numbers and designations in the various drawings indicate like elements.

### DETAILED DESCRIPTION

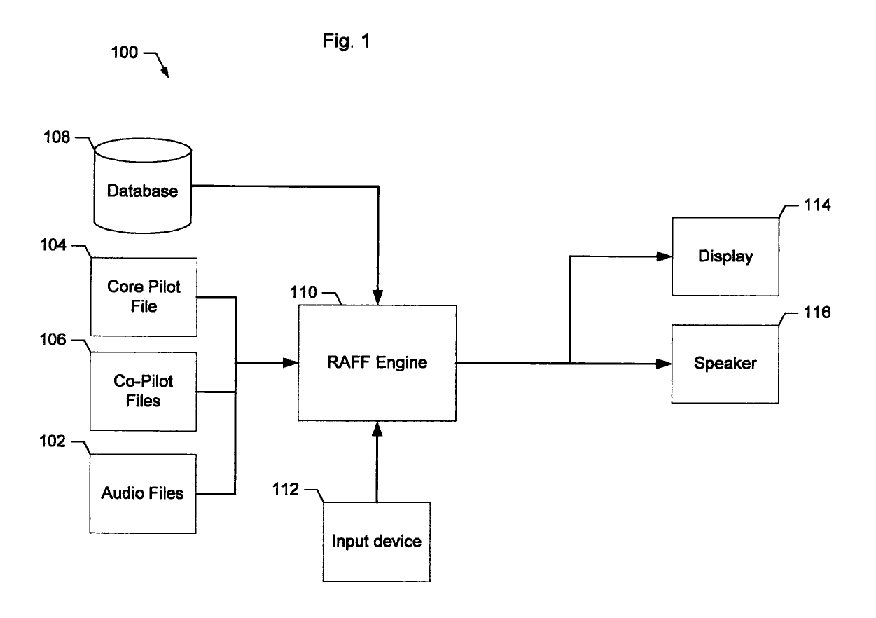

FIG. 1 illustrates a block diagram of an implementation of an example system 100 for playing enriched audio files. An enriched audio file can be any type of audio file, such as an audio book or a podcast, that is synchronously coupled to data, such as image data, video data and/or audio data, that can be asynchronously coupled from the data. A rich audio file format (RAFF) is an example of implementation of an enriched audio file. The example system 100 may be implemented as several components of hardware, each of which is configured to perform one or more functions, may be implemented in software where one or more software and/or firmware programs are used to perform the different functions, or may be a combination of hardware and software. In this example, the example system 100 includes an audio file 102, a core pilot file 104, one or more co-pilot files 106, a database 108, a RAFF engine 110, an input device 112, a display 114 and a speaker 116.

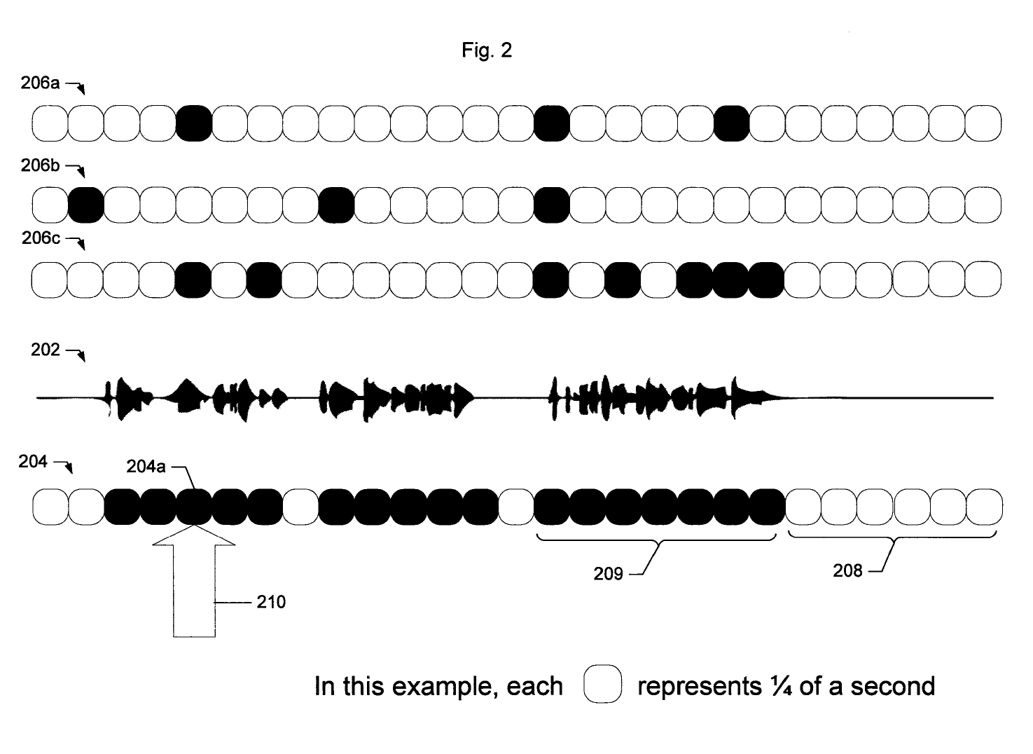

The audio file 102 contains spoken word programming and can be any type of audio file such as MP3 or Windows Media Audio. For example, the audio file 102 can be a word for word reading of a book or reference guide (e.g., an audio book). The audio file 102 can be played on any type of digital audio player such as an iPod or a laptop. A person of ordinary skill in the art will appreciate that the audio file 102 represents an audio waveform that has been digitized. A graphical representation of an example audio file 202 is shown in FIG. 2.

The core pilot file 104 is an alternative representation of the audio file 102 and used by the RAFF engine 110 to control playback of the audio file 102. In some implementations, the core pilot file 104 represents the audio waveform of the audio file 102 as a binary list (i.e., a series of 1's and 0's). In some implementations, the binary list is a linked list and the field of each node in the linked list is equal to 1 or 0. Each element of the list (“a block”) represents a portion of the audio wave form and indicates if the portion of the audio file is audible. For example, in some implementations, each block of the core pilot file 104 represents a ¼ second of the audio file 102. For each ¼ second of the audio waveform, if the magnitude of the audio waveform is greater than or equal to a predetermined threshold, the block of the core pilot file 204 is equal to 1. If the magnitude of the audio waveform is less than the predetermined threshold, the block of the core pilot file 104 is equal to 0. A person of ordinary skill in the art will appreciate that the core pilot file 104 can be implemented using different data structures other than a binary list. The predetermined threshold can correspond to a value representing audible sound levels or can be a value chosen to eliminate unwanted audio noise. Although the core pilot file 104 represents the audio waveform, the core pilot file 104 can be distributed separately from the audio file 102.

An example core pilot file 204 is illustrated in FIG. 2. As seen in FIG. 2, the core pilot file 204 is graphically represented as a series of blocks, where each block corresponds to a portion of the audio waveform 202. When the magnitude of each portion of the audio waveform 202 is above a predetermined threshold, the corresponding block of the core pilot file 204 is filled in (e.g., block 204a) to indicate that the portion of the audio waveform 202 is audible. If the magnitude of the portion of the audio waveform 202 is below the predetermined threshold, the corresponding block of the core pilot file 204 is not filled in to indicate that the portion of the audio waveform 202 contains no audible information.

The co-pilot files 106 represent timelines of events that are synchronized to the audio file 102 and the core pilot file 104. These events are intended to be played in a certain order accompanying particular segments or portions of the audio file 102. These events can enhance the listening experience by presenting multimedia data.

The co-pilot files 106 are divided into units of time (“blocks”) similar to the core pilot file 104. The co-pilot files 106 can have the same temporal resolution as the core pilot files 104. In other words, each block in a co-pilot file 106 (i.e. a co-pilot block) represents the same amount of time that each block in the core pilot file 104 (i.e., a core pilot block) represents.

In some implementations, the co-pilot files 106 are a linked list, where each node of the linked list corresponds to unit of time, such as ¼ of a second, and the field of each node can represent an event, such as displaying a picture or image, playing sounds such as music, beeps, or sound effects, or displaying text information. If the field does not contain an event, then the field can contain a null pointer, some other value to represent that no event is contained, or no value at all. In some implementations, the event is a pointer or an index into a list or database that contains the data associated with the events.

In some implementations, a co-pilot block that is associated with a co-pilot event is considered marked. The act of scheduling a co-pilot event to be performed at a certain time and associating that co-pilot event with a particular co-pilot block can be referred to as “marking” the block.

The system 100 can include different types of co-pilot files 106. For example, the system 100 can include a user event co-pilot file, a text event co-pilot file and a media event co-pilot file. The user event co-pilot file can be used to store user created information such as user bookmarks, user notes and annotations, voice notes recorded by the user, user progress and information about where the user last accessed the audio file 102. The text event co-pilot file can be used to store text-based events such as events to display a PDF document of the text being read back (similar to subtitles of the spoken word), events to display author determined “key words,” and information relating the enriched audio file to text based editions of a book. The media event co-pilot file can store multi-media based events such as events to display a video (e.g., a .mpg clip), an image (e.g., a PDF image) or play a sound (e.g., a .wav file), events to display sidebars and events to present interactive quizzes. In addition, the system 100 can include other types of co-pilot files not described here. In some implementations, the system 100 does not include any co-pilot files 106 and only includes a core pilot file 104.

An example user event co-pilot file 206a, an example text event co-pilot file 206b and an example media event co-pilot 206c are shown in FIG. 2. The co-pilot files 206a-c are illustrated as a series of blocks, where each block represents a unit of time. If an event is scheduled or planned for a particular unit of time, the block is filled in. If no event is scheduled or planned for a particular unit of time, the block is not filled in.

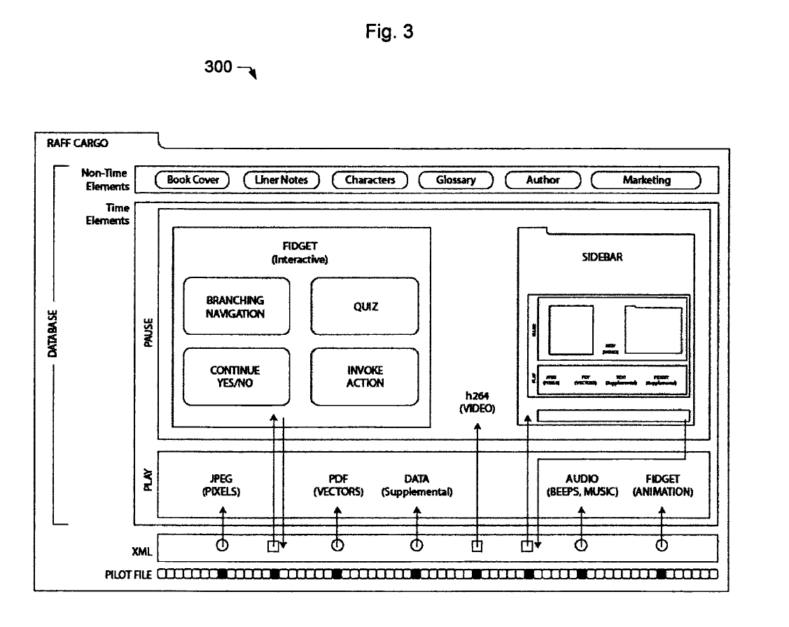

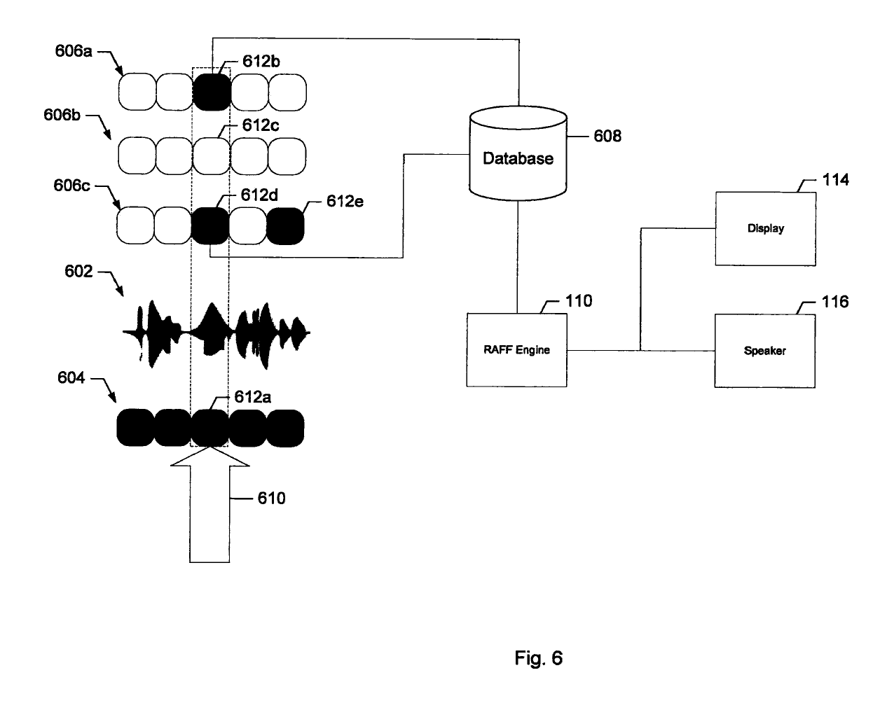

The database 108 can be configured to store different types of data and files. For example, the database 108 can store text data, multimedia data and user generated data such as bookmarks or voice notes. In some implementations, the database 108 is populated when an enriched audio file is loaded for the first time by the RAFF engine 110. For example, the RAFF engine 110 can receive a cargo file that includes the pilot file 104, the co-pilot files 106 and the data needed for the events such as images, videos, text based information such as a glossary or notes, audio clips or music and/or interactive data and uses this data to populate the database 108. The database 108 then contains all of the information used by the co-pilot events. An example cargo file 300 is shown in FIG. 3. In some implementations, the database 108 stores all of the event data associated with a particular co-pilot file chronologically and continuously within the database 108. For example, FIG. 6 shows a media co-pilot file 606c with two media co-pilot blocks that are associated with events (block 612d and block 612e). The database 108 can store the event data associated with media co-pilot block 612d in database entry 0 and the event data associated with the media co-pilot block 612e in database entry 1. The event data associated with the other co-pilot files would also be stored contiguously.

The RAFF engine 110 controls the playback of the enriched audio file by reading the audio file 102, the core pilot file 104 and/or the co-pilot files 106. The RAFF engine 110 can read a block of the core pilot file 104 and determine if the portion of the audio file corresponding to block should be played. The RAFF engine 110 can read a co-pilot block and determine if an event should be performed.

In some implementations, the RAFF engine 110 can also write to the co-pilot files 106 and the database 108. For example, the RAFF engine 110 can write to a block in the user event co-pilot file 106 to indicate that the user saved notes corresponding to this block. In some implementations, the RAFF engine 110 stores an event pointer or otherwise marks the block to indicate that an event is associated with the block. In addition, the RAFF engine 110 will write to the database 108 to store the data associated with the event. In some implementations, the RAFF engine 110 reads the audio file 102, the core pilot file 104 and the co-pilot files 106 simultaneously or substantially simultaneously.

In addition, the RAFF engine 110 can also read and/or write to the database 108. For example, if the RAFF engine 110 reads the text event co-pilot file 206b and determines that an annotation should be displayed, the RAFF engine 110 can access the database 108 and retrieve the requested text data. The RAFF engine 110 can use the pointer or the index stored in the text event co-pilot file 206b to access the database 108. As described above, the RAFF engine 110 can also read files (e.g., a cargo file 300) and load the contents of these files into the database 108.

As the RAFF engine 110 reads the core pilot file 104 and the co-pilot files 106, the RAFF engine 110 processes the events stored in these files. For example, the RAFF engine 110 can read the media event co-pilot file 206c and determine that a multimedia event should be played. The RAFF engine 110 will then access the database 108, retrieve the appropriate multimedia event and perform the multimedia event.

The core pilot files 104 and the co-pilot files 106 can be synchronized with the playback of the audio file 102, and the RAFF engine 110 can read all the files simultaneously. For example, the RAFF engine 110 can read the core pilot block and the co-pilot blocks corresponding to the same unit of time as the portion of the audio file being played. This allows the RAFF engine 110 to process the events stored in the co-pilot files 104 in the order the author intended and at the intended time in the audio file. For example, if the audio being played was describing the process of changing the oil in a car, one of the co-pilot files can cause a pictures demonstrating the oil change to be played as the audio program is describing the process. This synchronized playback is referred to as normal playback mode.

In addition, the RAFF engine 110 can enter an override mode and asynchronously perform the events stored in the co-pilot files 106 from the playback of the audio file 102. In some implementations, the override mode can cause the RAFF engine 110 to read co-pilot blocks that do not correspond to the portion of the audio file being played and allow for events to be performed out of the author's intended order. For example, the override mode will allow a later scheduled event to be performed before an event scheduled to be performed before the later scheduled event. In some implementations, the override mode can cause the RAFF engine 110 to access the database 108 and retrieve co-pilot events that do not correspond to the portion of the audio file being played without reading the co-pilot blocks. The retrieved co-pilot event can be performed out of order. Although the override mode allows events to be performed out of order, the RAFF engine 110 continues to play portions of the audio file that correspond to the core pilot file in accordance with the core pilot file 104. The override mode and the asynchronous reading of the co-pilot files 106 will be explained in greater detail below.

In some implementations, the RAFF engine 110 reads the core pilot file 104 to control the speed of playback according to a user selected playback speed. For example, the RAFF engine 110 can determine that portions of the audio file 102 are white space (i.e., segments of the audio file 102 that do not contain audio information that are intended to be heard or segments of the audio file 102 that are below certain decibel thresholds) and speed up (or slow down) the playback of the audio file 102 in these white space areas. The RAFF engine 110 does not change the playback speed of the non-white space portions of the audio file 102 and/or the core pilot file 104.

In some implementations, the user can choose to change the playback speed of the non-white space portions of the audio file 102 and/or the core pilot file 104 in addition changing to the playback speed of the white space portions. The RAFF engine 110 can display a warning to the user indicating that the overall experience may be deteriorated.

An example white space segment 208 is shown in FIG. 2. The white space segment 208 is approximately 1.5 seconds long. The playback speed can be used to accelerate (or slowdown) the playback of the audio file 102. For example, the playback speed can be selected so the rate of playback is two times faster than normal playback speed. The RAFF engine 110 will accelerate the playback of the white space segment 208 such that it is played in 0.75 seconds but does not accelerate the playback of the portions of the audio file 102 that correspond to the non-whitespace areas (e.g., segment 209). In some implementations, the RAFF engine 110 will accelerate the playback of the non-whitespace area 209 and the white space segment 208 such that these segments are played at twice the speed. In the alternative, the playback speed can be selected so the rate of playback is half of the normal playback speed. In this situation, the RAFF engine 110 will slow down the playback of the white space segment 208 such that it is played in 3 seconds but does not slow down the playback of the non-white space segment 209.

The input device 112 can be any type of input device such as a keyboard, touchscreen, or mouse. A user can use the input device 112 to control the system 100 or interact with the system 110.

The display 114 can be any type of display. For example, the display 114 can be as a liquid crystal (LCD) display or an organic light emitting diode (OLED) display. In addition, the display 114 can be any size.

The speaker 116 can be any type of speaker. For example, the speaker 116 can be a pair of headphones for personal listening or can be similar to a speaker found in speakerphones.

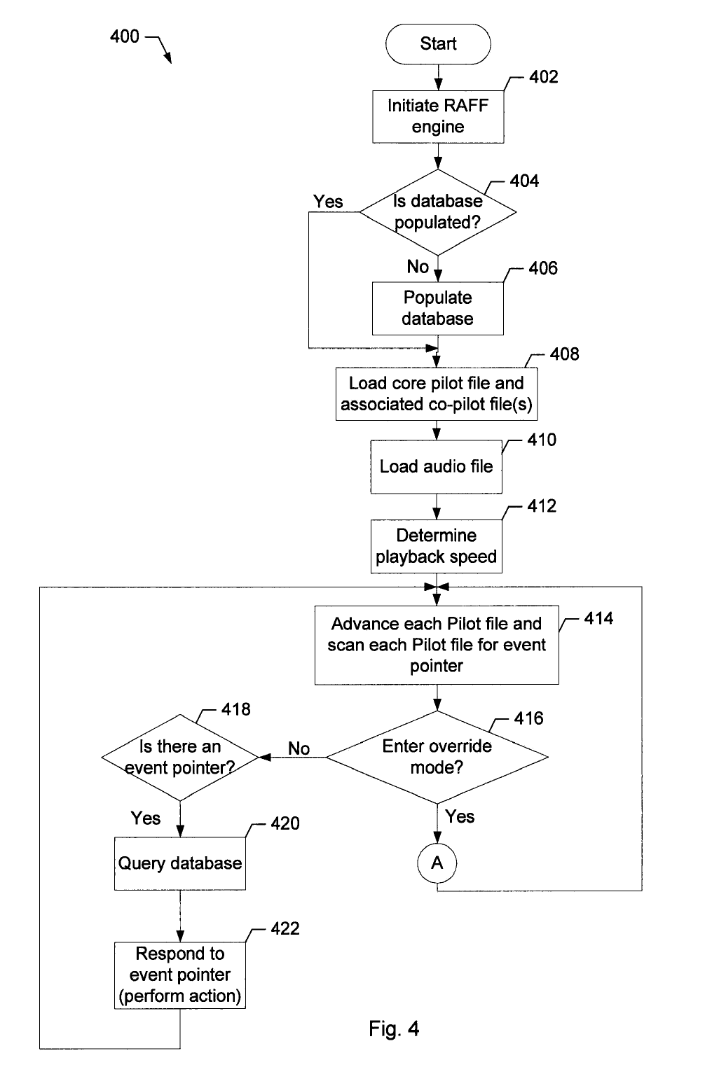

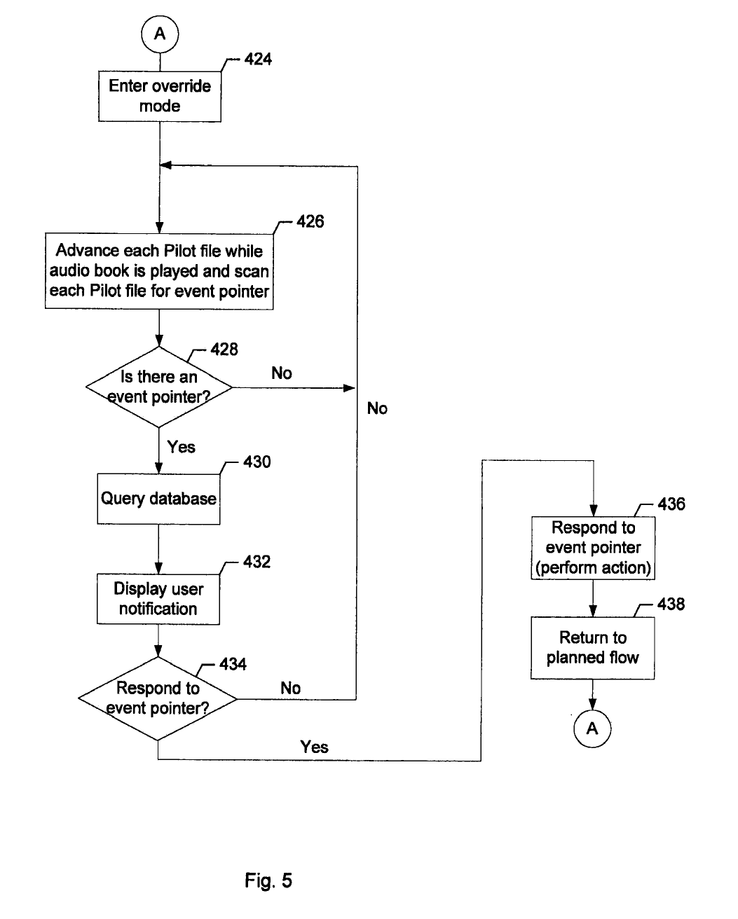

FIGS. 4 and 5 are flowcharts illustrating a process 400 to play enriched audio files. Process 400 can be implemented by the RAFF engine 110 of the example system 100. Preferably, the illustrated process 400 is embodied in one or more software programs that are stored in one or more memories and executed by one or more processors. However, some or all of the blocks of process 400 can be performed manually and/or by one or more devices. A person of ordinary skill in the art will appreciate that many other methods of performing process 400 can be used. For example, the order of the blocks may be altered, the operation of one or more blocks can be changed, blocks can be combined, and/or blocks can be eliminated.

Process 400 begins when a user launches the software program to play an enriched audio file, which initiates the RAFF engine 110, and chooses an enriched audio file to be played (block 402). For example, the user may launch RAFF Tube, an enriched audio file reader developed by Flying Car Ltd or another software application, and choose to listen to a particular enriched audio book. The RAFF engine 110 accesses the database 108 associated with the chosen enriched audio file and determines if the database 108 has been populated with data associated with the particular enriched audio book (block 404). Typically, the database 108 associated with the chosen enriched audio file is populated when the enriched audio file is loaded for the first time. If the database 108 associated with the chosen enriched audio file does not contain any information, the RAFF engine 110 accesses a file (e.g., the cargo file 300) and uses the information stored in the file to populate the database 108 (block 406).

After the database 108 is populated, the RAFF engine 110 loads the core pilot file 104 and any co-pilot files 106 that may be associated with the chosen enriched audio file (block 408). The RAFF engine 110 also loads the audio file 102 associated with the enriched audio file (block 410).

The RAFF engine 110 then determines the playback speed (block 412). As described above, the playback speed can be set by the user to control the speed the audio file 102 is played and the rate at which the core pilot file 104 and the co-pilot files 106 are read. In some implementations, the RAFF engine 110 determines the playback speed by accessing user preferences or retrieving a value stored in memory or the database 108.

The core pilot file 104 and co-pilot files 106 are then read by the RAFF engine 110 (block 414). The RAFF engine 110 can use a location index to indicate which core pilot block and which co-pilot blocks are being read and the portion of the audio file 102 being played. FIG. 2 shows a graphical representation of the location index 210.

In some implementations, the RAFF engine 110 reads the core pilot file 104 and the co-pilot files 106 simultaneously. For example, the RAFF engine 110 reads the core pilot block and the co-pilot block corresponding to the same unit of time and the audio file (e.g., normal playback mode). This is illustrated in FIG. 6 which shows a portion of a core pilot file 604, a portion of an audio file 602, a portion of an user event co-pilot file 606a, a portion of the text event co-pilot file 606b and a portion of the media event co-pilot file 606c. The location index 610 indicates that blocks 612a-d are being read by the RAFF engine 110. As seen in FIG. 6, the blocks 612a-d are being read and correspond to the same unit of time and the same portion of the audio file 602.

As the RAFF engine 110 reads the core pilot block (block 414), it determines if the portion of the audio file 102 corresponding to the core pilot block should be played. In some implementations, the RAFF engine 110 determines if the portion of the audio file 102 should be played by determining if the value of the core pilot block is equal to 1.

In some implementations, the RAFF engine 110 uses changes in the core pilot blocks to control whether the audio file 102 should be played. For example, if a first core pilot block is equal to 1, then the RAFF engine 110 determines that the audio file 102 should be played. The RAFF engine 110 continues to play the audio file 102 until the RAFF engine 110 reads a core pilot block equal to 0, and the audio file 102 is not played until the RAFF engine 110 reads a core pilot block equal to 1.

As the RAFF engine 110 reads the core pilot file 104 and the co-pilot files 106, the RAFF engine 110 also determines if the override mode should be entered (block 416). The override mode request can be caused by a user-generated input to the system. For example, in some implementations, the user can drag his finger across a portion of the touch screen or uses another input device 112 to enter the override mode.

If the override mode is not entered into, the normal playback mode is entered, and the RAFF engine 110 determines if the co-pilot blocks being read contain an event (block 418). In some implantations, the RAFF engine 110 determines if any of the co-pilot blocks have an event associated with the co-pilot block (“marked”) by detecting the presence of an event pointer. For example, FIG. 6 shows that the blocks 612b and 612d of the user event co-pilot file 606a and the media event co-pilot file 606c, respectively, contain an event pointer.

If the RAFF engine 110 determines that the co-pilot blocks do not contain an event, then the process returns to block 414 and advances the location index and reads the next block of the core pilot file 104 and the co-pilot files 106 (block 414). In some implementations, the RAFF engine 110 determines that the co-pilot blocks do not contain events because the co-pilot blocks contains no value or a null pointer.

If the RAFF engine 110 determines that at least one of the blocks being read contains an event (e.g., at least one co-pilot block contains an event pointer), the RAFF engine 110 queries the database 108 to retrieve the event data. In some implementations, the RAFF engine 110 uses the event pointer stored in the co-pilot block as an index into the database 108. The RAFF engine 110 then responds to the event (block 422). A person of ordinary skill in the art will appreciate that the RAFF engine's response depends on the event type. For example, the RAFF engine 110 can display images or videos in response to some events in the media event co-pilot file 106, can display “key words” or annotations in response to some events in the text event co-pilot file, or can show user notes or highlighting in response to some events in the user event co-pilot file. The process then returns to block 414 and advances the location index and reads the next block of the core pilot file 104 and the co-pilot files 106 (block 414).

An illustrative example of the normal playback mode is shown in FIG. 6. As shown by the position of the location index 610, the RAFF engine 110 reads core pilot block 612a, user event co-pilot block 612b, text event co-pilot block 612c, and media event co-pilot block 612d. The RAFF engine 110 determines that block 612b and block 612d contain events. The RAFF engine 110 then queries the database 108 and retrieves the data associated with blocks 612b and 612d. For example, the event data associated with block 612b can be a voice note that had been previously recorded by the user. The RAFF engine 110 will respond to the event by playing the voice note through the speaker 116. As another example, the event data associated with block 612d can be an interactive quiz that is to appear on the display 114. The RAFF engine 110 will present the interactive quiz on the display 114 and receive the user's responses to the quiz questions. After the user finishes the interactive quiz or otherwise exits the quiz, the RAFF engine 110 then advances location index 610 and reads the next core pilot block and the next co-pilot blocks.

If the RAFF engine 110 determined that the override mode was supposed to be entered (block 414), the RAFF engine 110 then enters the override mode (block 424 of FIG. 5). In some implementations, the override mode only performs events that do no disrupt the playback of the audio file 102. In some implementations, the override mode is a mode where the RAFF engine 110 reads the core pilot block and plays the portion of the audio file 102 corresponding to the core pilot block but reads co-pilot blocks corresponding to the location indicated by a override index. The override index is similar to the location index but is only used in the override mode and is advanced by the user. In addition, the override index can point to a co-pilot block that is at a different point in the audio file than the core pilot block. In other words, the override index can point to a co-pilot block that does not correspond to the core pilot block pointed to by the location index and allow for events to be performed out of the scheduled order. In some implementations, the override mode does not use an override index and directly accesses the contents of the database 108 to retrieve co-pilot event data.

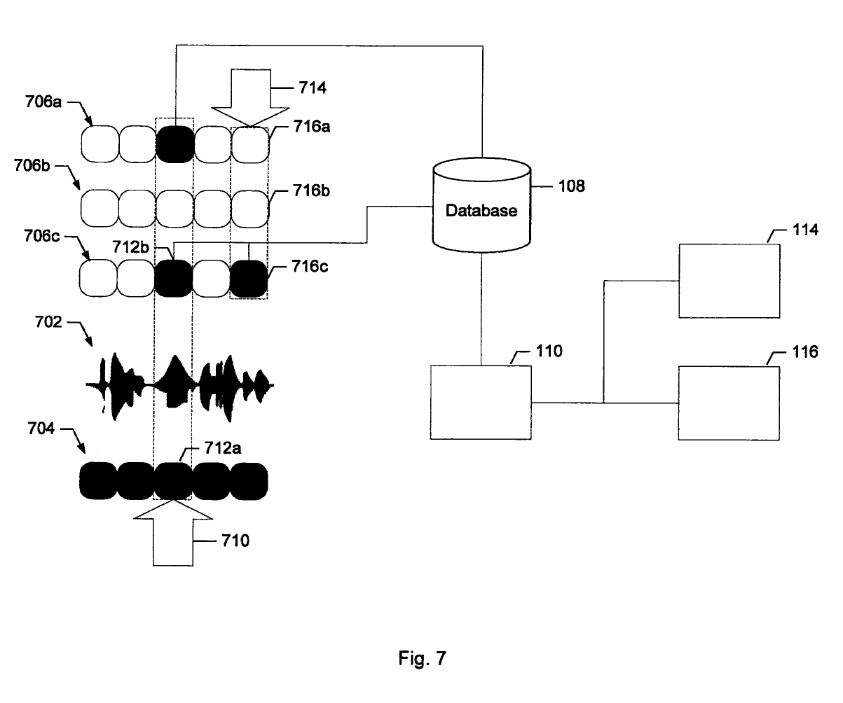

An example of the override mode is shown in FIG. 7. Location index 710 indicates that the RAFF engine 110 is reading core pilot block 712a and playing the portion of the audio file 702 corresponding to core pilot block 712a. In normal playback mode, co-pilot block 712b should be performed before co-pilot blocks 716a-c. However, override index 714 indicates that the RAFF engine 110 is reading user event co-pilot block 716a, text event co-pilot block 716b, and media event co-pilot block 716c. In other words, events in co-pilot blocks 716a-c can be performed before the earlier scheduled event stored in co-pilot block 712b.

The override index can be advanced forward in time (i.e., fast-forward) or can go backwards in time (i.e., rewind or reverse) according to the user's input. For example, in some implementations, the user can press a button to scroll through future events in co-pilot files 106. In other implementations, the user can drag his finger back and forth to fast-forward or rewind the events stored in the co-pilot files 106. This allows the user to have the sensation of flipping through a book or magazine.

After the override mode is entered (block 424), the RAFF engine 110 advances the location index and reads the next block in the core pilot file 104 and plays the portion of the audio file 102 corresponding to this block (block 426). In addition, the RAFF engine 110 also advances (or rewinds) the override index based on user input and reads the co-pilot files blocks located at the override index (block 426).

The RAFF engine 110 determines if the co-pilot blocks contain an event (block 428). Similar to block 418, the RAFF engine 110 can determine if the co-pilot blocks being read contains an event by detecting the presence of an event pointer.

If the RAFF engine 110 determines that the co-pilot blocks do not contain an event (e.g., the co-pilot blocks contain null pointers), then the process returns to block 426 and advances the location index and reads the next core pilot block. In addition, the RAFF engine advances (or rewinds) the override index according to the user requests and reads the next block of the co-pilot files 106 (block 426).

If the RAFF engine 110 determines that at least one of the co-pilot blocks contain an event, the RAFF engine 110 then queries the database 108 and retrieves the data associated with the event stored in the co-pilot block (block 430). In some implementations, the RAFF engine 110 uses the event pointer stored in the co-pilot block as an index into the database 108. The RAFF engine 110 then displays a user notification on the display 112 to indicate that an event can be shown (block 432). In some implementations, the user notification is a preview of the event. For example, if the event is a media event that displays an image, a thumbnail of the image can be shown. As another example, if the event is a user event that plays a voice note previously recorded by the user, an icon representing audio information can be shown. In some implementations, the user notification is a text notification that briefly describes the event or displays the event title. In some implementations, the user notification can also be an sound to indicate that an event can be shown.

The RAFF engine 110 then determines if the event should be displayed (block 434). The RAFF engine 110 can determine if the event should be displayed by scanning for user input to indicate that the event should be displayed. In some implementations, the user can click on the user notification. For example, if the RAFF engine 110 shows an icon to represent the event, the user can click the icon to indicate that the event should be displayed. In addition, the RAFF engine 110 can determine that the event should not be displayed if a predetermined amount of time has elapsed (i.e., a timeout period has elapsed) and no input has been received from the user. The length of the timeout period can be set by the user or can be predefined by software developers. In some implementations, the RAFF engine 110 can determine that the event should not be displayed by receiving a user input that indicates the user wants to continue scanning through the co-pilot events.

If the RAFF engine 110 determines that the event should be displayed (block 434), similar to block 422, the RAFF engine 110 responds to the event (block 436). The RAFF engine's response depends on the event type. For example, the RAFF engine 110 displays images or videos in response to some events in the media event co-pilot file 106, can display “key words” or annotations in response to some events in the text event co-pilot file, or can show user notes or highlighting in response to some events in the user event co-pilot file.

In some implementations, only events that do not interrupt the playback of the audio file 102 are performed. For example, the override mode would allow pictures to be displayed but would not allow a movie with audio to be played.

The RAFF engine 110 then returns to the normal mode (block 438). In some implementations, the RAFF engine 110 can return to the normal mode by setting the override index to be equal to the location index. In some implementations, the RAFF engine 110 can return to the normal mode by loading the data of the most recently encountered event pointer. The process then returns to block 414 and advances the location index and reads the next block of the core pilot file 104 and the co-pilot files 106 (block 414).

If the RAFF engine 110 determines that the event should not be displayed (e.g., the user does not click on the icon or the user continues to advance the override index), the process returns to block 426 and continues to advance the location index and read the next block in the core pilot file 104 and play the portion of the audio file 102 that corresponds to this block (block 426). In addition, the RAFF engine 110 continues to advance (or rewind) the override index based on the user's inputs and reads the co-pilot files 106.

An illustrative example is shown in FIG. 7. As shown by the position of the location index 710, the RAFF engine 110 reads block 712a of the core pilot file 704 and plays the portion of the audio file 702 corresponding to block 712a. As seen by its relative position in the media event co-pilot block 706c, co-pilot block 712b is scheduled to be performed before co-pilot block 716c. However, because the RAFF engine 110 is in override mode and the position of the override index 714, co-pilot block 712b is not read. Instead, the RAFF engine 110 reads user event co-pilot block 716a, text event co-pilot block 716b and media event co-pilot block 716c. The RAFF engine 110 determines that block 716c contains an event. The RAFF engine 110 then queries the database 108 and retrieves the event data associated with block 716c and displays a user notification to indicate that an event can be performed. For example, the RAFF engine 110 can show an icon to indicate that music can be played. The RAFF engine 110 will scan for user input to indicate that the event should be performed (e.g., the user clicks on the icon or a timeout period elapses) or for user input to indicate that the event should not be performed (e.g., the user continues to advance the override index 714). If the RAFF engine 110 determines that the event should be performed, the RAFF engine 110 performs the event and then returns to the normal playback mode by setting the location of the override index 714 to be equal to the location index 710. The RAFF engine 110 then advances location index 710 and reads the next block in core pilot file 704 and the next block in the co-pilot files 706a-c and plays the portion of the audio waveform corresponding to these blocks.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

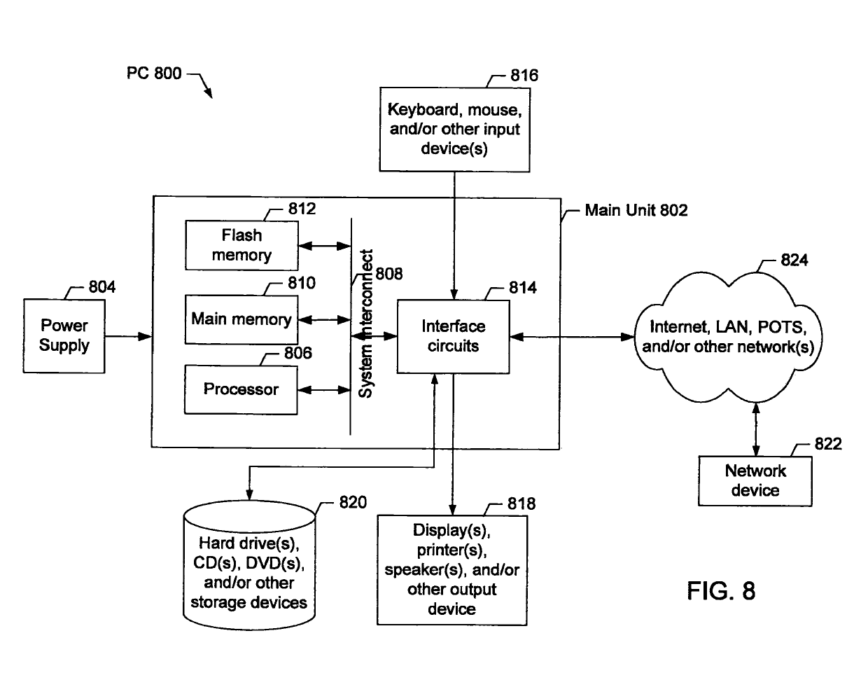

An example of one such type of computer is shown in FIG. 8 which shows a block diagram of a programmable processing system (system) 800 suitable for implementing apparatus or performing methods of various aspects of the subject matter described in this specification. In the example illustrated, the playback device 800 includes a main processing unit 802 powered by a power supply 804. The main processing unit 802 can include a processor 806 electrically coupled by a system interconnect 808 to a main memory device 810, a flash memory device 812, and one or more interface circuits 814. In an example, the system interconnect 808 is an address/data bus. A person of ordinary skill in the art will readily appreciate that interconnects other than busses can be used to connect the processor 806 to the other devices 810, 812, and 814. For example, one or more dedicated lines and/or a crossbar can be used to connect the processor 806 to the other devices 810, 812, and 814.

The system 800 can be preprogrammed, in the flash memory device 812, for example, or it can be programmed (and reprogrammed) by loading a program from another source (for example, from a floppy disk, a CD-ROM, or another computer).

The interface circuit(s) 814 can be implemented using any type of well known interface standard, such as an Ethernet interface and/or a Universal Serial Bus (USB) interface. One or more input devices 816 can be connected to the interface circuits 814 for entering data and commands into the main processing unit 802. For example, an input device 816 can be a keyboard, mouse, touch screen, track pad, track ball and/or a voice recognition system.

One or more displays, printers, speakers, and/or other output devices 818 can also be connected to the main processing unit 802 via one or more of the interface circuits 814. The display 818 can be a liquid crystal displays (LCD), an organic light-emitting diode (OLED) display or any other type of display. The display 818 can be used to generate visual indications of data generated during operation of the main processing unit 802. The visual indications can include prompts for human operator input, playback speed, and audio wave forms.

The main unit 802 can be coupled to one or more storage devices 820, such as a hard drive, a compact disk (CD) drive, a digital versatile disk drive (DVD), removable storage devices such as a Secure Digital (SD) card. The one or more storage devices 820 are suitable for storing executable computer programs, including programs embodying aspects of the subject matter described in this specification, and data including enriched audio files or other digital media files such as digital video and audio files.

The computer system 800 can also exchange data with other devices 822 via a connection to a network 824. The network connection can be any type of network connection, such as an Ethernet connection, digital subscriber line (DSL), telephone line, coaxial cable, etc. The network 824 can be any type of network, such as the Internet, a telephone network, a cable network, and/or a wireless network. The network devices 822 can be any type of network devices 822. For example, the network device 822 can be a client, a server, a hard drive, etc.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, an alternate override mode can implemented such that the RAFF engine 110 accesses the database 108 and performs some co-pilot events (e.g., displaying images or other events that do not stop the audio playback) asynchronously from the core pilot file 104 without using an override index. The RAFF engine 110 uses the most recently performed co-pilot event as an index into the database 108 and advances/reverses the index to retrieve other co-pilot event data.

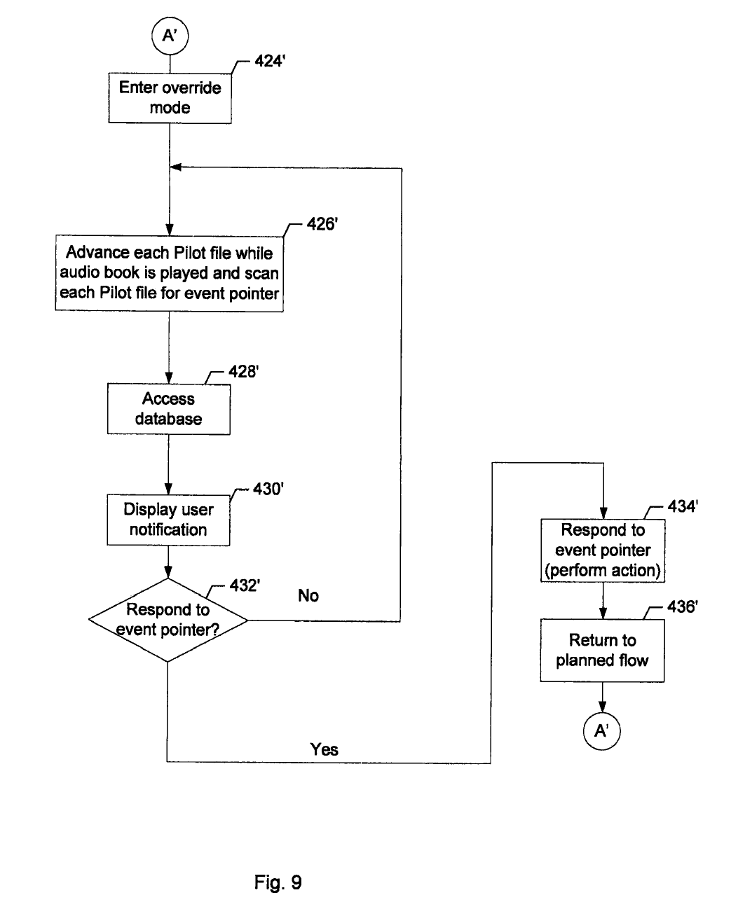

FIG. 9 illustrates an example alternate override mode and can be substituted for blocks 424-438 of FIG. 5 in the process 400. After the alternate override mode is entered (block 424′), the RAFF engine 110 advances the location index, reads the next block in the core pilot file 104 and plays the portion of the audio file 102 corresponding to this block (block 426′). In addition, the RAFF engine 110 also reads the blocks in the co-pilot files 106 that correspond to the position location index (block 426′).

Using the most recent event pointer as an index into the database 108 (“a database index”), the RAFF engine 110 determines if the database index should be incremented or decremented and accesses the database 108 (block 428′). The database index is incremented when the user input is fast-forwarding through the co-pilot events. The database index is decremented when the user input is rewinding through the co-pilot events.

It should be noted that in this implementation of the alternate override mode, the database 108 stores the co-pilot event data sequentially and chronologically. For example, entry 0 in the database 108 would correspond to the first media co-pilot event and entry 1 in the database 108 would correspond to the next media co-pilot event scheduled to be performed.

The RAFF engine 110 then displays a user notification on the display 112 to indicate that an event can be shown (block 430′). In some implementations, the user notification is a preview of the event. For example, if the event is a media event that displays an image, a thumbnail of the image can be shown. As another example, if the event is a user event that plays a voice note previously recorded by the user, an icon representing audio information can be shown. In some implementations, the user notification is a text notification that briefly describes the event or displays the event title. In some implementations, the user notification can also be a sound to indicate that an event can be shown.

The RAFF engine 110 then determines if the event should be displayed (block 432′). The RAFF engine 110 can determine if the event should be displayed by scanning for user input to indicate that the event should be displayed. In some implementations, the user can click on the user notification. For example, if the RAFF engine 110 shows an icon to represent the event, the user can click the icon to indicate that the event should be displayed. In addition, the RAFF engine 110 can determine that the event should not be displayed if a predetermined amount of time has elapsed (i.e., a timeout period has elapsed) and no input has been received by the user. The length of the timeout period can be set by the user or can be predefined by software developers. In some implementations, the RAFF engine 110 can determine that the event should not be displayed by receiving a user input that indicates the user wants to continue scanning through the co-pilot events.

If the RAFF engine 110 determines that the event should be displayed (block 432′), similar to block 422, the RAFF engine 110 performs the event (block 434′). The RAFF engine's response depends on the event type. For example, the RAFF engine 110 displays images or videos in response to some events in the media event co-pilot file 106, can display “key words” or annotations in response to some events in the text event co-pilot file, or can show user notes or highlighting in response to some events in the user event co-pilot file. In some implementations, the override mode only allows events that do not interrupt the playback of the audio file 102 to be performed.

It should be noted that the RAFF engine 110 continues to read the core pilot file 104 and playback the corresponding portions of the audio file 102 while determining if the event should be displayed. The location index is continuously advanced.

The RAFF engine 110 then returns to the normal mode (block 436′). The process then returns to block 414 and advances the location index and reads the next block of the core pilot file 104 and the co-pilot files 106 (block 414).

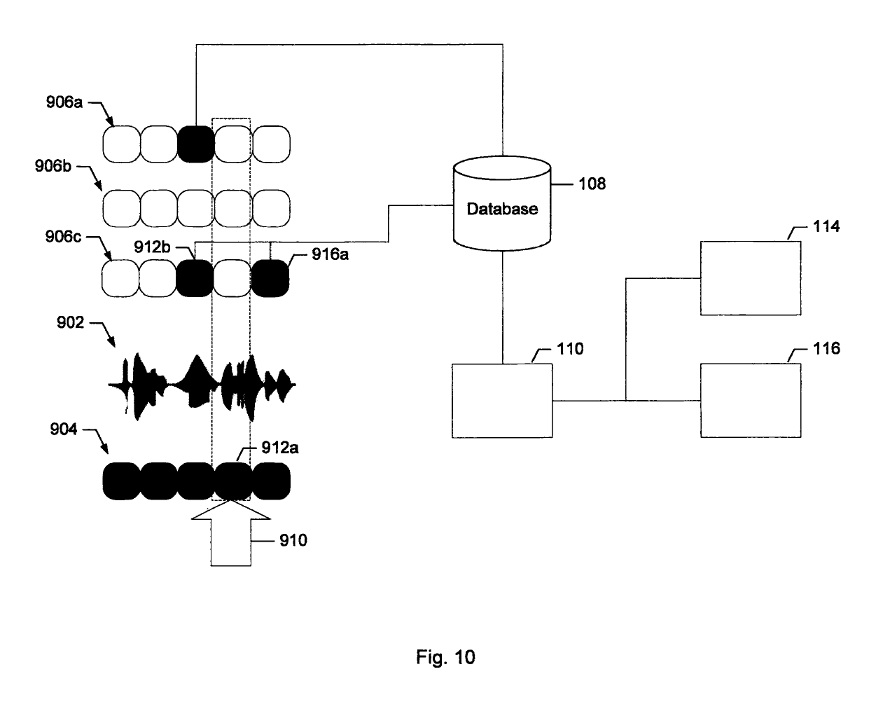

An illustrative example of this alternate override mode is shown in FIG. 10. As shown by the position of the location index 910, the RAFF engine 110 reads block 912a of the core pilot file 904 and plays the portion of the audio file 902 corresponding to block 912a. Because the media co-pilot block 912b had been recently performed by the RAFF engine 110, the RAFF engine 110 uses the event pointer stored in co-pilot block 912b as the database index. If the user wishes to go forward in time, the RAFF engine 110 increments the database index and accesses the next database entry. In this example, the next database entry would correspond to the co-pilot event data stored in the database 108 associated with media co-pilot block 916a. The RAFF engine 110 then displays a user notification to indicate that an event can be performed. The RAFF engine 110 will scan for user input to indicate that the event should be performed or for user input to indicate that the event should not be performed. If the RAFF engine 110 determines that the event should be performed, the RAFF engine 110 displays the event and then returns to the normal playback mode.

What is claimed is:

1. A computer implemented method to playback an enriched audio file, the method comprising:
advancing a file, wherein the file comprises a timeline of events synchronized to an audio file, wherein the timeline of events comprises a first event scheduled to be performed before a second event;
playing the audio file;
entering an override mode such that performance of the events is not synchronized to the audio file;
performing the second event before the first event while the audio file is played; and
exiting the override mode such that the timeline of events is synchronized to the audio file.

2. The method of claim 1 wherein the file comprises a pilot file.

3. The method of claim 1 wherein the file is a master and the audio file is a slave.

4. The method of claim 1 wherein the first and second events comprise an image event, a video event, an audio event, a text event, a multimedia event or a RAFF event.

5. The method of claim 1 wherein playback of the audio file is independent of the timeline of events.

6. The method of claim 1 wherein the timeline of events is generated separate from the audio file.

7. The method of claim 1 wherein the audio file comprises a spoken-word audio file and a soundtrack.

8. The method of claim 1 further comprising:
receiving user input to enter the override mode; and
receiving user input to exit the override mode.

9. The method of claim 1 wherein playing the audio file comprises a linear playback according to a chronological order of the audio file.

10. The method of claim 1 wherein the audio file comprises an audio book, a podcast, or a music file.

11. A computer implemented method to playback an enriched audio file, the method comprising:
advancing a file, wherein the file comprises a timeline of events synchronized to an audio file;
playing the audio file; and
performing an event asynchronously from a playback of the audio file.

12. The method of claim 11 wherein the file is a pilot file.

13. The method of claim 11 wherein the file is a master and the audio file is a slave.

14. The method of claim 11 wherein the event comprises an image event, a video event, an audio event, a text event, a multimedia event or a RAFF event.

15. The method of claim 11 wherein the timeline of events comprises a first event and a second event, wherein the first event is scheduled to be performed before the second event.

16. The method of claim 11 further comprising:
entering an override mode such that the timeline of events is not synchronized to the audio file before performing the event; and
exiting the override mode such that the timeline of events is synchronized to the audio file.

17. The method of claim 11 wherein playback of the audio file is independent of the timeline of events.

18. The method of claim 11 wherein the timeline of events is generated separate from the audio file.

19. The method of claim 11 wherein the audio file comprises a spoken-word audio file and a soundtrack.

20. The method of claim 11 wherein the audio file comprises an audio book, a podcast, or a music file.

21. A computer implemented method of enhancing an audio file, comprising:
marking an audio file with one or more event markers at a specific time or time period in the audio file;
retrieving an event associated with the one or more event markers; and
displaying the event at the specific time or time period marked by the event marker during playback of the audio file.

22. A computer implemented method of enhancing an audio file comprising:
marking the audio file with a first event marker at a specific time or time period in the audio file;
marking the audio file with a second event marker at a specific time or time period in the audio file;
retrieving a first event associated with the first event marker and retrieving a second event associated with the second event marker;
displaying the first event on a user interface during playback of the audio file wherein the first event is displayed at the specified time in the audio file designated by the first event marker; and
displaying the second event on a user interface during playback of the audio file wherein the second event is displayed at the specified time in the audio file designated by the second audio file.

23. The method of claim 22, further comprising:
displaying the second event on a user interface in accordance with a user instruction, wherein the display of the second event is in advance of the time or time period in the audio file designated by the second event marker.

24. The method of claim 23, further comprising:
displaying the first event after display of the second event and before the time or time period in the audio file designated by the second event marker.

25. The method of claim 22 wherein the event comprises an image event, a video event, an audio event, a text event, a multimedia event or a RAFF event.

26. A computer implemented method to playback an enriched audio file, the method comprising:
playing an audio file,
wherein a timeline of events is synchronized to the audio file and the timeline of events comprises a first event scheduled to be performed before a second event;
entering an override mode such that the timeline of events is not synchronized to the audio file;
performing the second event before the first event while the audio file is played; and
exiting the override mode such that the timeline of events is synchronized to the audio file.

27. The method of claim 26 further comprising:
receiving user input to enter the override mode; and
receiving user input to exit the override mode.

28. The method of claim 26 wherein playing the audio file comprises a linear playback according to the chronological order of the audio file.
